(19) United States
(12) Patent Application Publication
(10) Pub. No.: US 2026/0371458 A1
(43) Pub. Date: Nov. 19, 2026

(54) LIGHTING ARRANGEMENT

(71) Applicant: SIGNIFY HOLDING B.V., EINDHOVEN (NL)

(72) Inventors: TIES VAN BOMMEL, HORST (NL); ERIK PETRUS JOHANNES MALLENS, DEN BOSCH (NL)

(21) Appl. No.: 19/515,651

(22) PCT Filed: Aug. 23, 2024
(86) PCT No.: PCT/EP2024/073742

§ 371 Date: Mar. 2, 2026

(30) Foreign Application Priority Data
Sep. 5, 2023 (EP) 23195328.2

(51) Int. Cl. H05B 45/20; F21K 9/232; F21K 9/235; F21S 4/24; F21Y 103/10; F21Y 113/17; F21Y 115/10; H05B 45/10; H05B 47/155; H05B 47/17

(52) U.S. Cl. CPC H05B 45/20; F21K 9/232; F21K 9/235; F21S 4/24; H05B 45/10; H05B 47/155; H05B 47/17; F21Y 2103/10; F21Y 2113/17; F21Y 2115/10

(57) ABSTRACT

A lighting arrangement (100) providing arrangement light, comprising an elongated carrier (110), a plurality LEDs (130) arranged on the elongated carrier, wherein the plurality of LEDs comprises a first set (200) of n blue LEDs, a second set (210) of n green LEDs, a third set (220) of n red LEDs, wherein the plurality of LEDs comprises n groups (400) of blue, green and red LEDs in a clustered (410) or a pitched (420) configuration, The lighting arrangement further comprises a controller (300) coupled to the plurality of groups of LEDs, wherein the controller is configured to individually control an operation of each LED of the plurality of groups of LEDs in the clustered and pitched configurations, respectively.

### FIELD OF THE INVENTION

This disclosure relates to illumination arrangements, in particular LED light strips.

### BACKGROUND OF THE INVENTION

Recently, LED (light emitting diode) strip arrangements have gained popularity due to their versatility and reasonable cost. LED light strips can be easily installed, come in many variants with respect to length, color and brightness options, and are cost-efficient. LED strip arrangements are commonly designed with LEDs arranged on an elongated carrier. Existing LED strip arrangements may have the disadvantage of spottiness, while in other cases, the near field may not have white light.

It is an object of the present invention to try to overcome the previously stated deficiencies and improve the overall performance, functionality and/or appearance of LED strip arrangements. One way to improve LED strips is by finetuning LED lighting to produce better light. A tuned light spectrum can make a difference; however, the optimum spectrum depends on the application, daytime (circadian rhythm), user preference, etc.

### SUMMARY OF THE INVENTION

It is of interest to overcome at least some of the deficiencies of the architectures in the present technologies and to provide LED strip arrangements which finetune LED lighting.

This and other objects are achieved by providing a lighting arrangement having the features recited in the independent claim. Preferred embodiments are defined in the dependent claims.

According to the present invention, there is provided a lighting arrangement providing arrangement light. The lighting arrangement comprises an elongated carrier, and a plurality of light emitting diodes, LEDs, arranged on the elongated carrier.

The plurality of LEDs comprises a first set of n blue LEDs, a second set of n green LEDs, and a third set of n red LEDs.

The first set of n blue LEDs is configured to emit a first light, in a first wavelength range, λ1, of 430-490 nm, wherein, for any blue LEDᵢ, i=1, . . . , n, where n>=3, the blue LEDᵢ emits a peak wavelength, λBᵢ, in the first wavelength range, λ1, the peak wavelengths λBᵢ≠λBⱼ for j=1, . . . , n and i≠j.

The second set of n green LEDs is configured to emit a second light in a second wavelength range, λ2, of 500-590 nm, wherein, for any green LEDᵢ, i=1, . . . , n, where n>=3, the green LEDᵢ emits a peak wavelength, 2Gᵢ, in the second wavelength range, λ2, the peak wavelengths λGᵢ≠λGⱼ for j=1, . . . , n and i≠j.

The third set of n red LEDs configured to emit a third light in a third wavelength range, λ3, of 600-690 nm, wherein, for any red LEDᵢ, i=1, . . . , n, where n>=3, the red LEDᵢ emits a peak wavelength, λRᵢ, in the third wavelength range, λ3, the peak wavelengths 2Rᵢ≠λRⱼ for j=1, . . . , n and i≠j.

The plurality of LEDs comprises n groups of LEDs, wherein each group k=1, . . . , n, wherein n>=3, comprises at least one blue LEDₖ, at least one green LEDₖ, and at least one red LEDₖ. The plurality of groups of LEDs further comprises one of a first configuration, wherein each group of LEDs is confined within an area, A, with radius, r, and wherein the plurality of groups of LEDs is distributed on the elongated carrier such that any two consecutive groups of LEDs are separated by at least a first distance, D₁, wherein D₁>3·r, and a second configuration, wherein the groups of LEDs are arranged in at least one array of individually arranged LEDs, wherein any two consecutive LEDs are of different color and are separated by at least a second distance, D₂, preferably D₂>1 mm, and a controller coupled to the plurality of groups of LEDs. The controller is configured to individually control an operation of each LED of the plurality of groups of LEDs. The controller is also configured to, in a first operational mode control the first configuration and, in a second operational mode, control the second configuration. In the first operational mode, OM1, the arrangement light has a first correlated color temperature, CCT1, and a first spectral distribution, SD1. In the second operational mode, OM2, the arrangement light has a second correlated color temperature, CCT2, and a second spectral distribution, SD2, wherein |CCT2−CCT1|≤300K and SD1≠SD2.

According to a second aspect of the invention, there is provided an LED lighting device. The LED lighting device comprises a lighting arrangement according to the first embodiment of the invention and any of its preferred embodiments. The LED lighting device further comprises a cover and an electrical connection. The cover comprises an at least partially transparent material that at least partially encloses the lighting arrangement. The electrical connection is connected to the lighting arrangement for a supply of power to the plurality of LEDs of the lighting arrangement.

Thus, the present invention is based on the idea of providing a lighting arrangement comprising at least three sets of each of blue, green and red LEDS. Each set of same-colored LEDs emits a respective colored light having a different dominant peak wavelength, as compared to the at least wo other sets of same-colored LEDs, within the wavelength for the specific color. The plurality of LEDs may be set up in a first configuration where first configuration, wherein each group of LEDs is confined within an area, A, with radius, r, and wherein the plurality of groups of LEDs is distributed on the elongated carrier such that any two consecutive groups of LEDs are separated by at least a first distance, D1, wherein D1>3·r. The plurality of LEDs may also be set up in a second configuration, where the groups of LEDs are arranged in at least one array of individually arranged LEDs and any two consecutive LEDs are of different color and are separated by at least a second distance, D2. A controller is coupled to the plurality of groups of LEDs and individually controls an operation of each LED of the plurality of groups of LEDs. The controller is arranged to adjust two consecutive groups of LEDs each to a correlated color temperature, CCT, The controller controls a first configuration in a first operational mode, OM1, where the arrangement light has a first correlated color temperature, CCT1, and a first spectral distribution, SD1, the controller controls a second configuration in a second operational mode, OM2, which controls a second configuration, the arrangement light has a second correlated color temperature, CCT2, and a second spectral distribution, SD2, wherein |CCT2−CCT1|≤300K and SD1≠SD2.

The present invention is advantageous in that it finetunes LED lighting to produce improved light.

According to an embodiment of the present invention, a difference, DCCT, in color correlated temperature, CCT, between any two groups of LEDs, fulfills |DCCT|<300 K.

According to an embodiment of the present invention, the luminous flux of each group in the first operational mode may be different from the second operational mode. According to an embodiment of the present invention, the peak wavelengths of a k+1^{th} group, λBk+1, λGk+1, λRk+1, respectively, are higher than the corresponding peak wavelengths λBk, λGk, λRk of a preceding adjacent k^{th} group, along an axis, A, of the elongated carrier.

According to an embodiment of the present invention, the peak wavelengths of a k+1^{th} group, λBk+1, λGk+1, λRk+1, respectively, are alternatingly higher and lower than the corresponding peak wavelengths λBk, λGk, λRk of a preceding adjacent k^{th} group, along an axis, A, of the elongated carrier.

According to an embodiment of the present invention, the peak wavelengths for two corresponding LEDs from two consecutive groups differ by a value Δλ, where Δλ≥20 nm.

According to an embodiment of the present invention, the plurality of groups of LEDs is distributed on the elongated carrier according to the second configuration, wherein any two consecutive LEDs within any of the groups are separated by the second distance, D2, wherein any two consecutive LEDs from different groups are separated by a third distance, D3, wherein D3>=D2.

According to an embodiment of the present invention, the groups of LEDs are separated by any of a Warm-White, WW, LED of 2700-3000K, and a Cold-White, CW, LED of above 4000K. According to an example, each one of the respective WW LED and CW LED may be separated from a closest LED of the adjacent group of LEDs by the first distance D1 or the second distance, D2.

According to an embodiment of the present invention, the plurality of groups of LEDs is distributed on the elongated carrier according to the first configuration, and wherein the LEDs within each group of LEDs are arranged together in a unit, i.e. a LED package.

According to an example, the plurality of LEDs comprises direct-emitting LEDs.

According to an example, the plurality of LEDs comprises a plurality n of groups, where each one of the groups comprises at least one blue LED, at least one green LED, and one red LED. In this embodiment, each group of LEDs is confined with an area, A, with a radius, r.

According to an embodiment of the present invention, the plurality of LEDs comprises LEDs covered by an encapsulant comprising a luminescent material, wherein the luminescent material is configured to convert the LED light emitted by the covered LEDs to LED light having one of the peak wavelengths λB, λG, λR of the group to which the respective LEDs belong. The LED light emitted by the covered LEDs to LED light may have at least two peak wavelengths λB, λG, λR of the group to which the respective LEDs belong.

According to an example, the luminescent material comprises at least one phosphor for converting the LED light.

According to an example, the controller is configured to adjust the luminous flux of the respective groups of LEDs individually.

According to an embodiment of the present invention, in the lighting arrangement, at least one of a ratio between peak wavelengths of blue LEDs from two consecutive groups, λBi/λBᵢ₊₁, a ratio between peak wavelengths of green LEDs from two consecutive groups, λGᵢ/λGᵢ₊₁, and a ratio between peak wavelengths of red LEDs from two consecutive groups, λRᵢ/λRᵢ₊₁, is varied between the first operational mode and the second operational mode for at least 20%, meaning that for obtaining the first operational mode and the second operational mode, the ratios of the peak wavelengths of two consecutive groups should be at least 20% apart

In a preferred embodiment, at least two of the ratios λBᵢ/λBᵢ₊₁, λGᵢ/λGᵢ₊₁, and λRᵢ/λRᵢ₊₁, are varied between the first operational mode and the second operational mode, and one of the varied ratios is increased and one of the varied ratios is decreased.

In embodiments, in a first operational mode, OM1, the arrangement light may have a first correlated color temperature, CCT1, and a first spectral distribution, SD1, and in the second operational mode, OM2, the arrangement light may have a second correlated color temperature, CCT2, and a second spectral distribution, SD2, and in a third operational mode, OM3, the arrangement light may have a third correlated color temperature, CCT3, and a third spectral distribution, SD3, wherein |CCT2−CCT1|<300K and |CCT3−CCT2|≤300K and |CCT3−CCT1|≤300K, and SD1≠SD2≠SD3.

In embodiments, in a first operational mode, OM1, the arrangement light may have a first correlated color temperature, CCT1, and a first spectral distribution, SD1, and in the second operational mode, OM2, the arrangement light may have a second correlated color temperature, CCTλ, and a second spectral distribution, SD2, and in a third operational mode, OM3, the arrangement light may have a third correlated color temperature, CCT3, and a third spectral distribution, SD3, the arrangement light may have a fourth correlated color temperature, CCT4, and a fourth spectral distribution, SD4, wherein |CCT2−CCT1|≤300K and |CCT3−CCT2|<300K and |CCT3−CCT1|<300K and |CCT4−CCT1|≤300K and |CCT4−CCT2|≤300K and |CCT4−CCT3|<300K, and SD1≠SD2≠SD3≠SD4.

In embodiments, SD1 may have a dominant peak wavelength at a different wavelength as SD2. In embodiments, SD2 may have a dominant peak wavelength at a different wavelength as SD3. In embodiments, SD3 may have a dominant peak wavelength at a different wavelength as SD4.

In embodiments, |CCT2−CCT1 | may be ≤200K or ≤150K.

In embodiments, the lighting arrangement may be a LED strip e.g. a flexible LED strip.

In embodiments, the first set of n blue LEDs may comprise at least one phosphor-converted blue LED e.g. a violet LED with a blue phosphor.

In embodiments, the second set of n green LEDs may comprise at least one phosphor-converted green LED e.g. a blue LED with a green phosphor.

In embodiments, the third set of n red LEDs may comprise at least one phosphor-converted red LED e.g. a blue LED with a red phosphor.

In embodiments, the first set of n blue LEDs may comprise at least one direct-emitting blue LED.

In embodiments, the second set of n green LEDs may comprise at least one direct-emitting green LED.

In embodiments, the third set of n red LEDs may comprise at least one direct-emitting red LED.

According to an embodiment of the present invention, there is provided a luminaire. The luminaire comprises a lighting arrangement according to any one of the preceding embodiments, or a LED lighting device according to one of the previous embodiments. The controller may be functionally connected to at least one of a user interface, a sensor, and a clock module. The controller is configured to control the LEDs based on input of said user interface, sensor, or clock module. The luminaire may be elongated. The luminaire may have an elongated light exit window.

A correlated color temperature, CCT, is a specification of the color appearance of the light emitted by a light source, relating its color to the color of light from a reference source when heated to a particular temperature, measured in degrees Kelvin (K).

An operational mode means a configuration for performing an operational scenario that activates specific functions.

A peak wavelength means the wavelength where the spectrum of the light source reaches its maximum.

A configuration means a set-up of individual LEDs.

A controller means any kind of unit or device configured to control the LEDs of the lighting arrangement.

An encapsulant is a structure that at least partially encloses the carrier or the LEDs. The encapsulant can scatter the lights or has a phosphor that converges the light to another color.

A unit of LEDs means that the LEDs are grouped together, aggregated, enclosed, or in close vicinity to each other in a unit, e.g. a LED package.

### BRIEF DESCRIPTION OF THE DRAWINGS

This and other aspects of the present invention will now be described in more detail, with reference to the appended drawings showing embodiment(s) of the invention.

FIG. 1 schematically shows a light spectrum according to the prior art.

FIG. 2 schematically shows a light spectrum according to an exemplifying embodiment of the present invention.

FIGS. 3a, 3b, and 3c schematically show a lighting arrangement according to exemplifying embodiments of the present invention.

FIGS. 4a, 4b, 4c, 4d, 4e and 4f schematically show details of lighting arrangements according to exemplifying embodiments of the present invention.

FIG. 5 schematically shows a LED lighting device comprising a lighting arrangement according to an exemplifying embodiment of the present invention.

Regarding the figures in this disclosure, as the lighting arrangements to be described comprise LEDs of various colors and nuances of the colors, in order to fulfil the requirements for figures, patterns and densities of the patterns are used to facilitate understanding of the disclosed concept. Typically, the specific colors blue, green and red are illustrated by various respective patterns, and the densities of the patterns illustrate the nuances of the colors.

### DETAILED DESCRIPTION OF THE INVENTION

LED strips may be designed with individual LEDs arranged with a distance therebetween, along an axis A, a so-called “pitched” architecture. The LEDs of a pitched structure may emit white light, e.g. Warm White (WW), or Cold White (CW), or Red (R), Green (G) and Blue (B) light. Another example architecture is the so-called “clustered” architecture where “RGB units” are arranged at the carrier and each RGB unit comprises at least one red, at least one green, and at least one blue LED, arranged together in one and the same physical unit, e.g. a LED package. Both pitched and clustered architectures have their respective advantages. In the pitched structure, the near field experience of the emitted light is perceived as smoother, but, for the pitched architecture, the temperature along the LED strip arrangement is smoother. The clustered architecture has the disadvantage of spottiness, while in the pitched architecture, the disadvantage may be that the near field may not have white light.

The visible spectrum of solar light has a spectrum with wavelengths between about 400-750 nm, i.e. from below purple up to above red. As conventional standard LEDs emit light with one specific peak wavelength, solutions have been proposed to broaden the respective peak wavelengths of LEDs to achieve a more natural light based on people's perception. For instance, Warm White (WW), and Cold White (CW) LEDs have been developed by covering a LED with an appropriate encapsulant.

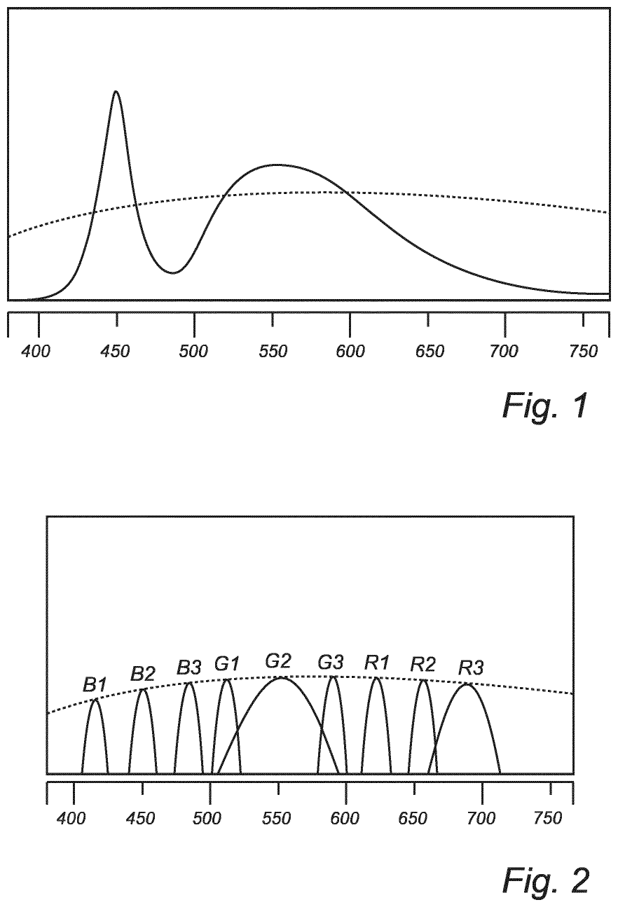

FIG. 1, which is a schematic diagram, illustrates an example where a blue LED having a peak wavelength λ of 450 nm is covered with an encapsulant to transform the emitted light with a blue peak wavelength to light with a wider wavelength range between 500 and 700 nm, to achieve a more natural light in an environment. However, as seen in FIG. 1, the blue peak is not fully suppressed and the resulting spectrum has two dominant peaks, the blue of 450 nm, and a wider one about 570 nm. Such a light may be perceived as unnatural, and stressful.

FIG. 2, which is a schematic diagram, illustrates the resulting light spectrum of an inventive lighting arrangement according to an exemplifying embodiment.

The lighting arrangement provides arrangement light and comprises a plurality of LEDs emitting light with respective peak wavelengths. In this embodiment, there are three blue wavelengths B1, B2, B3; three green wavelengths G1, G2, G3; and three red wavelengths R1, R2, R3, and together the LEDs' emitted light result in a light spectrum that will be perceived more natural by people.

Some implementations of lighting arrangements 100 will now be described by means of various exemplifying embodiments.

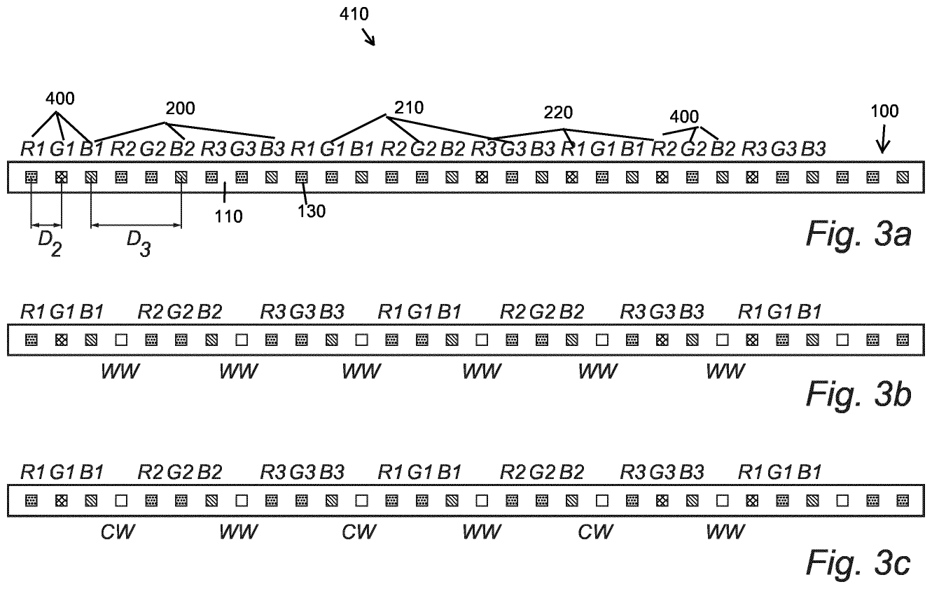

With reference to FIGS. 3a-c, which are schematic illustrations, lighting arrangements for providing arrangement light will now be described, in accordance with exemplifying embodiments.

FIG. 3a illustrates a lighting arrangement 100 with a pitched design. A plurality of LEDs 130 is arranged on an elongated carrier 110. The plurality of LEDs 130 comprises a first set 200 of n blue LEDs configured to emit first light in a first wavelength range λ1 of 430-490 nm; a second set 210 of n green LEDs configured to emit second light in a second wavelength range λ2 of 500-590 nm; and a third set 220 of n red LEDs configured to emit third light in a third wavelength range λ3 of 600-690 nm.

The first set 200 of blue LEDs comprises n types of blue LEDs, whereof each type is adapted to emit blue light of a respective peak wavelength λBᵢ, i=1, . . . , n. The different peak wavelengths λBᵢ, i=1, . . . , n differ from each other such that the λBᵢ≠λBⱼ for j=1, . . . , n and i≠j. Correspondingly, the second set 210 of green LEDs comprises n types of green LEDs, whereof each type is adapted to emit green light of a respective peak wavelength λGᵢ, i=1, . . . , n. The different peak wavelengths λGᵢ, i=1, . . . , n differ from each other such that the Gᵢ≠λGⱼ for j=1, . . . , n and i≠j. The third set 220 of red LEDs comprises n types of red LEDs, whereof each type is adapted to emit red light of a respective peak wavelength λRᵢ, i=1, . . . , n. The different peak wavelengths λRᵢ, i=1, . . . , n differ from each other such that the λRᵢ≠λRⱼ for j=1, . . . , n and i≠j.

In this embodiment, where n=3 for the blue LEDs 200, there is one type of blue LEDs adapted to emit blue light with a peak wavelength λB₁, another type of blue LEDs adapted to emit blue light with a peak wavelength λB₂, and yet another type of blue LEDs adapted to emit blue light with a peak wavelength λB₃. The peak wavelengths λB₁, λB₂, and λB₃, differ from each other, but are all within the first wavelength range λ1 of 430-490 nm. In this embodiment, n=3 also for the green LEDs 210, and there are three types of green LEDs adapted to emit green light with respective peak wavelengths λG₁, λG₂, and λG₃, that differ from each other but are all within the second wavelength range λ2 of 500-590 nm.

Correspondingly, n=3 also for the red LEDs 220, and there are three types of red LEDs adapted to emit red light with respective peak wavelengths λR₁, λR₂, and λR₃, that differ from each other but are all within the third wavelength range λ3 of 600-690 nm.

In the above-described embodiments, the difference in peak wavelengths 42 for two corresponding LEDs from two consecutive groups 400, e.g. between two blue LEDs λB₁, and λB₂, or λB₂, and λB₃, could be as low as Δλ≥25 nm, preferably Δλ≥20 nm, more preferably Δλ≥15 nm, and most preferably as low as Δλ≥10 nm. The corresponding differences in peak wavelengths Δλ also applies for two corresponding green LEDs from consecutive groups, respective and two corresponding green LEDs from consecutive groups.

The plurality of LEDs comprises a plurality n of groups 400, where each one of the groups comprises at least one blue LED, at least one green LED, and one red LED. In this embodiment, the LEDs 130 are arranged according to a pitched configuration 410, with the groups 400 arranged after each other along the carrier 110, where two consecutive LEDs 130 are separated by a distance D₂. The distance between two consecutive LEDs 130 is equal along the carrier 110, whether or not the two consecutive LEDs 130 belong to the same group 400 or two adjacent groups 400. Typically, the distance D₂ is at least 1 mm, or at least 2 mm, such as at least 3 mm.

In this embodiment, the LEDs 130 of the pitched configuration 410 is set to: R1, G1, B1, R2, G2, B2, R3, G3, B3, R1, G1, B1, R2, G2, B2, R3,G3, B3, R1,G1, B1, R2, G2, B2, R3, G3, B3, . . . , as illustrated in FIG. 3a.

It is to be noted that the above-described lighting arrangement 100 is not limited to n=3 types of LEDs for the respective colors red, green, and blue. The lighting arrangement may be designed with any appropriate number of types of LEDs for each of the above defined wavelength ranges, i.e. colors. The numbers of types of LEDs may further vary between the different wavelength ranges. For instance, a designer may select to design the lighting arrangement 100 with three types of blue LEDs λB₁, λB₂, and λB₃, four types of green LEDs λG₁, λG₂, λG₃, and λG₄, but two types of red LEDs λR₁, and λR₂, within the disclosed concept, when appropriate. In such an alternative design, instead the order will be: R1, G1, B1, R2, G2, B2, R3, G3, B1, R1, G4, B2, R2, G1, B1, R3, G2, B2, R1, G3, B1, R2, G4, B2, R3, G1, B1, and so on.

In addition, the lighting arrangement 100 comprises a controller (not shown) that is coupled to the of plurality of LED groups 400. The controller 300 is configured control an operation of each LED 130 of the plurality of groups 400. The controller is configured to control the LEDs according to at least two operational modes, OM. In a first operational mode OM1, the arrangement light has a first correlated color temperature CCT1 and a first spectral distribution SD1, and in the second operational mode OM2, the arrangement light has a second correlated color temperature CCT2 and a second spectral distribution SD2. With the above disclosed lighting arrangement, for two selected spectral distributions SD1, SD2, the difference between the CCT1 and CCT2 could be as little as below 300 K, i.e. |CCT λ−CCT1|300K and SD1≠SD2. It is to be noted that the disclosed concept is not limited thereto and that yet smaller differences in correlated color temperatures may be achieved when put into practice. For instance, differences of |CCT2−CCT1|<250K may be preferred, |CCT2−CCT1|<200K may be more preferred, and |CCT2−CCT1|≤150K most preferred. The spectral distributions SD1, SD2 may be set by controlling by the luminous flux or radiometric power of the various groups 400 of LEDs.

For instance, for a LED strip with three colors, R, G, B, and three variants 1, 2, 3 of each color, a first spectral distribution SD1 may be set by controlling the luminous fluxes according to: R1=80%; R2=20%; R3=0%; G1=50%; G2=40%; G3=10%; and B1=50%; B2=50%; B3=0%. Correspondingly, a second spectral distribution SD2 may be set by controlling the luminous flux according to: R1=40%; R2=30%; R3=30%; G1=40%; G2=30%; G3=30%; and B1=60%; B2=30%; B3=10%. By appropriately controlling the luminous flux or radiometric power between the groups 400, an adapted or “tailor made” arrangement light could be achieved, and a user will be enabled to appropriately get a desired arrangement light by selecting an appropriate operational mode OM.

Since the emission peak wavelengths are different, per definition the luminous flux may vary because it depends on the distance of the peak with respect to eye sensitivity curve. However, it may be desirable to apply further correction. For example, if a spectrum with much R2 is desirable, only a small amount of R1 should be added. Since R1 is clustered together with B1 and G1, if the cluster of R1-G1-B1 needs to generate white light, then the amount of B1 and G1 also needs to be lowered. In another alternative, clustered RGB LEDs may not emit white light (or emit white light at a distance from the BBL); in such a case, the correction of the G2 and B2 may, possibly, not needed.

In the above-described pitched configuration 410, the respective group 400 comprises one blue LED, one green LED, and one red LED each. However, in order achieve a furthermore adapted emitted light, the lighting arrangement may be alternatively designed within the disclosed concept.

The FIGS. 3b-c illustrates two alternative designs of the lighting arrangement 100 described above. These two embodiments are based on the embodiment described with reference to FIG. 3a, and additional LEDs have been added to the groups 400 of LEDs. In FIG. 3b, a WW (Warm-White) LED has been added to each one of the groups 400 of LEDs. Typically, LED strips use a RGB-W architecture e.g. RGB-WW (warm white). Adding a white LED will further improve the quality (e.g. CRI, Color Rendering Index) of the light because of the different peaks in white light. Typically, WW is used for its high red content in the white light. Of course, a combination of WW+CW (cool white) will even further improve the light quality because also an optimal design for high CCT is present. In FIG. 3c, a WW LED has been added to every odd group 400 of LEDs, and a CW (Cold-White) LED has been added to every even group 400 of LEDs. Typically, a WW LED emits light between 2700-3000K, and a CW LED emits light above 4000K.

Even if the above-described embodiments have been described for lighting arrangements with pitched configurations 410, where the LEDs 130 arranged with a distance D₂ between adjacent LEDs 130, the invented concept is not limited to fixed configurations. Alternatively, the inventive concept may be applied also for clustered configurations of the LEDs, which will be defined below in conjunction with related example embodiments.

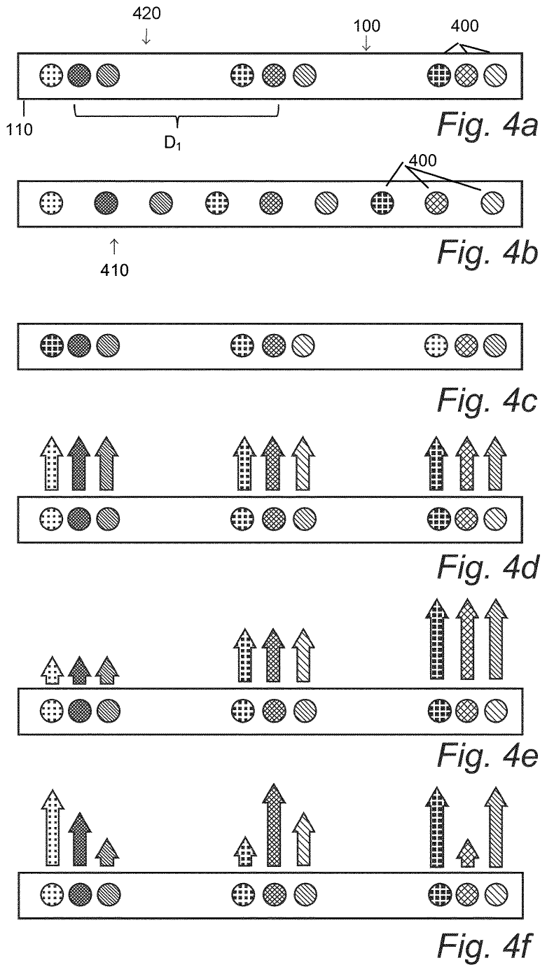

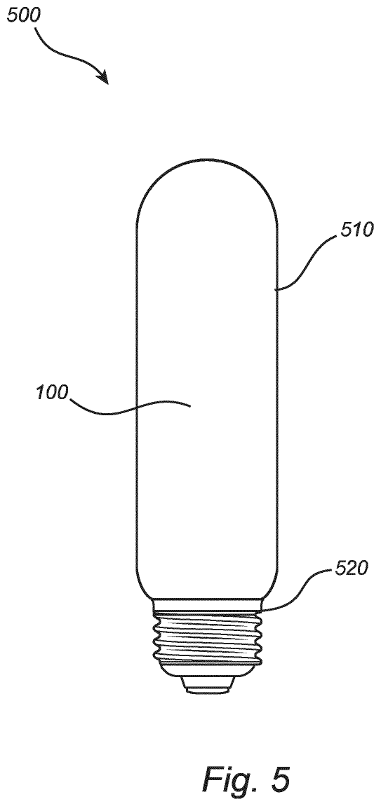

With reference to the FIGS. 4a-f, which are schematic illustrations, some example embodiments that are related to above disclosed embodiments will now be described. The lighting arrangements are non-limitingly illustrated for three respective groups of LEDs for illustrative purposes. However, it is to be noted that the inventive concept is not limited to a specific number of groups of LEDs. The carrier may comprise further groups and proceed along its axis with a suitable number of groups when appropriate.

It is understood that the lighting arrangements normally comprise further components to achieve optimal performance in operation, such as control processors that was illustrated in the figures above. However, in the figures below any such components have been omitted to focus on the inventive concept and to facilitate the understanding.

FIG. 4a, schematically illustrates a lighting arrangement 100 where LEDs are arranged on a carrier 110 according to a clustered configuration 420. Similarly, to above the LEDs are arranged in a sequence R1, G1, B1, R2, G2, B2, R3, G3, B3. The centers of two adjacent groups 400 are located a distance Di from each other. Each respective group 400 comprises one blue, one green and one red LED, but the light emitted by LEDs of the corresponding color of two groups differ in nuances. For instance, the emitted light of the two blue LEDs B1 and B2 differ in wavelengths about 20 μm. Similarly, the light emitted by the blue LEDs B2 and B3 differ in wavelengths correspondingly. As seen in FIGS. 4a and 4c, respectively, the LEDs of each respective group 400 are arranged together such that the distances r between LEDs within a group 400 are smaller than the distances D₁ between the groups 400. For instance, if the LEDs of one group 400 are arranged within a radius of 2 mm and the distance D₁ between the groups 400 is at least 8 mm, or within a radius of 3 mm and the distance D1 is at least 10 mm, a requirement that D₁>3r is fulfilled.

FIG. 4b, schematically illustrates a similar lighting arrangement 100 as shown in FIG. 4a, but with the difference that the LEDs are arranged according to a pitched configuration 410 instead of the clustered configuration.

FIG. 4c, schematically illustrates a related lighting arrangement as shown in FIG. 4a. In this exemplifying, however, is the LEDs arranged differently in the groups 400 to achieve a flexible and adapted light. In this embodiment the LEDs are arranged as B3, G1,R1 in the left group, as B2, G2, R2 in the middle group, and B1, G3, R3 in the right group. Thereby, by placing the LED appropriately in a suitable manner, the resulting light experience may be adapted to the user's needs. Typically, the manufacturer may offer lighting arrangements with different configurations, e.g. pitched or clustered configurations, and with different arrangements of the LEDs within the groups, to various categories of users.

To achieve a further appropriate and user-adapted light experience, the lighting intensities for the LEDs may be varied.

FIG. 4d, schematically illustrates a situation where all groups have the same lighting intensity.

FIG. 4e, schematically illustrates another situation where the lighting intensities are varied between the groups.

FIG. 4f, schematically illustrates yet another situation where the lighting intensities are varied within the groups.

The intensities may be varied and set by the users by selecting desired and appropriate operations modes OM1, OM2, etc.

The embodiment examples described above have been schematically described for pitched configurations and for clustered configurations, respectively. However, also combinations of pitched configurations and clustered configurations will be covered by the inventive scope. For instance, a lighting arrangement 100 of an exemplifying embodiment, that is related to some of the above-described embodiments, may comprise a combination of pitched and clustered groups.

Regarding the clustered configurations 420, the groups 400 of LEDs have been illustrated as LEDs arranged beside each other for illustrative purposes. However, when put into practice the LEDs of a group are typically located in one and the same physical unit, e.g. three sub-LEDs arranged together and encapsulated by an encapsulant. The encapsulant may comprise a luminescent material like phosphorous. Such an encapsuled physical unit is confined with an area A with a radius r.

A controller is used to individually control B1, B2, [B3], G1, G2, [G3], R1, R2, [R3]. The controller is configured by using a central processing unit, [CPU], to control said strip LEDs such that in a first operational mode all the clustered (RGB)ₙ or pitched (R-G-B)ₙ groups emit white light having the same correlated color temperature (i.e. a normal LED strip mode): CCT1(BL1+GL1+RL1)=CCT2(BL2+GL2+RL2)=CCT3(BL3+GL3+RL3). BL1 is the light from B1, GL1 is the light from G1, and RL1 is the light from R1, and the resulting light from a group of B1+G1+R1 achieves CCT1. Correspondingly, BL2, GL2, and RL2, are the lights from the respective B2, G2, and R2 that together as another group achieves CCT2, etc.

In other operational modes all different possible/optimized spectral compositions can be made different optimized spectra can be generated by using different colored distribution of different groups. For instance, the resulting light from groups of LEDs with different Spectral Distributions SD may be controlled by the CPU to acquire the same desired Correlated Color Temperature CCT for various operational modes. E.g., in a third operational mode, a desired CCT may be achieved for two different groups of LEDs which Spectral Distributions vary.

In an embodiment, all groups emit light but at different luminous fluxes so as to provide a continuous line of light.

In another exemplary embodiment, said LED strip comprises direct-emitting LEDs and phosphor-converted LEDs, especially for green and red colors.

In a further exemplary embodiment, one of the following architectures are used:
(R1G1B1-R2G2B2)n or (R1-G1-B1-R2-G2-B2)n
(R1G1B1-R2G2B2-R3G3B3)n or (R1-G1-B1-R2-G2-B2-R3-G3-B3)n
(R1G1B1-R2G2B2-R3G3B3-R2G2B2)n or (R1-G1-B1-R2-G2-B2-R3-G3-B3-R2-G2-B2)n

As illustrated by the above disclosed exemplifying embodiments the disclosed LED strip can be used as a normal LED strip or as a LED strip based light organ, where all different possible spectral compositions can be made.

RGB LEDs between groups differ in peak emission wavelength. However, it is not needed that R2>R1, B2>B1 and G2>G1. It is also possible to have R2>R1, B2>B1 while G2<G1. Other combinations are possible as well.

Each LED is associated with one specific fixed peak wavelength. Only the color point of a RGB LED cluster may be adapted by varying the different amounts of R, G and B light.

FIG. 5 schematically shows a LED lighting device 500 comprising a lighting arrangement 100 according to an exemplifying embodiment of the present invention. The LED lighting device 500 further comprises a cover 510 comprising an at least partially transparent material, wherein the cover 510 at least partially encloses the lighting arrangement 100, and an electrical connection 520 connected to the lighting arrangement 100 for a supply of power to the plurality of LEDs of the lighting arrangement 100.

A lighting arrangement of some of the above described exemplifying embodiments may be designed as a LED lighting device wherein the arrangement light in the first operational mode is white light having a correlated color temperature in a range from 2000K to 6500K and a Color Rendering Index (CRI) of at least 80, and arrangement light in the second operational mode is white light having a correlated color temperature in a range from 2000K to 6500K and a CRI of at least 80. The person skilled in the art realizes that the present invention is by no means limited to the preferred embodiments described above. On the contrary, many modifications and variations are possible within the scope of the appended claims.

1. A lighting arrangement providing arrangement light, comprising
an elongated carrier,
a plurality of light emitting diodes, LEDs, arranged on the elongated carrier,
wherein the plurality of LEDs comprises
a first set of n blue LEDs configured to emit a first light in a first wavelength range, λ1, of 430-490 nm, wherein, for any blue LEDᵢ, i=1, . . . , n, where n>=3,
blue LEDᵢ emits a peak wavelength, λBᵢ, in the first wavelength range, λ1, the peak wavelengths λBᵢ≠λBⱼ for j=1, . . . , n and i≠j;
a second set of n green LEDs configured to emit a second light in a second wavelength range, λλ, of 500-590 nm, wherein, for any green LEDᵢ, i=1, . . . , n, where n>=3,
green LEDᵢ emits a peak wavelength, λGᵢ, in the second wavelength range, λλ, the peak wavelengths λGᵢ≠λGᵢ for j=1, . . . , n and i≠j,
a third set of n red LEDs configured to emit third light in a third wavelength range, λ3, of 600-690 nm, wherein, for any red LEDᵢ, i=1, . . . , n, where n>=3,
red LEDᵢ emits a peak wavelength, λRᵢ, in the third wavelength range, λ3, the peak wavelengths λRᵢ≠λRⱼ for j=1, . . . , n and i≠j,
wherein the plurality of LEDs comprises n groups of LEDs, wherein each group
k=1, . . . , n, wherein n>=3, comprises
at least one blue LEDₖ, at least one green LEDₖ, and at least one red LEDₖ,
and wherein the plurality of groups of LEDs comprises one of
a first configuration, wherein each group of LEDs is confined within an area, A, with a radius, r, and wherein the plurality of groups of LEDs is distributed on the elongated carrier such that any two consecutive groups of LEDs are separated by at least a first distance, D₁, wherein D₁>3·r, and
a second configuration-, wherein the groups of LEDs are arranged in at least one array of individually arranged LEDs, wherein any two consecutive LEDs are of different color and are separated by at least a second distance, D₂, and
wherein the peak wavelengths of a k+1th group, λBk+1, λGk+1, λRk+1, respectively, are higher than or are alternatingly higher and lower than the corresponding peak wavelengths λBk, λGk, λRk of a preceding adjacent kth group (400), along an axis, A, of the elongated carrier (110), and wherein the peak wavelengths for two corresponding LEDs from two consecutive groups (400) differ by a value ?λ, where ?λ≥20 nm, and
a controller coupled to the plurality of groups of LEDs, wherein the controller is configured to individually control an operation of each LED of the plurality of groups of LEDs, and wherein the controller is configured to adjust two consecutive groups of LEDs each to a correlated color temperature, CCT, in a first operational mode and in a second operational mode, control one of
the first configuration, and
the second configuration,
wherein in the first operational mode, OM1, the arrangement light has a first correlated color temperature, CCT1, and a first spectral distribution, SD1, and in the second operational mode, OM2, the arrangement light has a second correlated color temperature, CCTλ, and a second spectral distribution, SD2, wherein |CCTλ−CCT1|≤300K, and SD1≠SD2.

2. The lighting arrangement according to claim 1, wherein a difference, D_{CCT}, in color correlated temperature, CCT, between any two groups of LEDs, fulfills |D_{CCT}|≤300 K.

3. The lighting arrangement according to claim 1, wherein the luminous flux of each group in the first operational mode is different from the second operational mode.

4. (canceled)

5. (canceled)

6. (canceled)

7. The lighting arrangement according to claim 5, wherein the plurality of groups of LEDs is distributed on the elongated carrier according to the second configuration, wherein any two consecutive LEDs within any of the groups are separated by the second distance, D₂, wherein any two consecutive LEDs from different groups are separated by a third distance, D₃, wherein D₃≥D₂.

8. The lighting arrangement according to claim 7, wherein the groups of LEDs are separated by at least one of:
a Warm-White, WW, LED of 2700-3000K, and
a Cold-White, CW, LED of above 4000K.

9. The lighting arrangement according to claim 4, wherein the plurality of groups of LEDs is distributed on the elongated carrier according to the first configuration, and wherein the LEDs within each group of LEDs are arranged together in a unit.

10. The lighting arrangement according to claim 1, wherein the plurality of LEDs comprises LEDs covered by an encapsulant comprising a luminescent material, wherein the luminescent material is configured to convert the LED light emitted by the covered LEDs to LED light having one of the peak wavelengths λB, λG, λR of the group that the respective LEDs belong to.

11. The lighting arrangement according to claim 1, wherein at least one of
a ratio between peak wavelengths of blue LEDs from two consecutive groups, λBᵢ/λBᵢ₊₁,
a ratio between peak wavelengths of green LEDs from two consecutive groups λGᵢ/λGᵢ₊₁, and
a ratio between peak wavelengths of red LEDs from two consecutive groups, λRᵢ/λRᵢ₊₁,
differ for at least 20% between the first operational mode and the second operational mode.

12. The lighting arrangement according to claim 11, wherein at least two of the ratios λBᵢ/λBᵢ₊₁, λGᵢ/λGᵢ₊₁, and λRᵢ/λRᵢ₊₁, differ between the first operational mode and the second operational mode, and wherein one of the ratios is increased and one of the ratios is decreased.

13. The lighting arrangement according to claim 1, wherein the arrangement light in the first operational mode is white light having a correlated color temperature, CCT, in a range from 2000K to 6500K and a color rendering index, CRI of at least 80, and wherein arrangement light in the second operational mode is white light having a CCT in a range from 2000K to 6500K and a CRI of at least 80.

14. A LED lighting device, comprising
a lighting arrangement according to claim 1, a cover comprising an at least partially transparent material, wherein the cover at least partially encloses the lighting arrangement, and
an electrical connection connected to the lighting arrangement for a supply of power to the plurality of LEDs of the lighting arrangement.

15. A luminaire, comprising one of
a lighting arrangement according to claim 1, and
a LED lighting device,
wherein the controller is functionally connected to at least one of a user interface, a sensor, and a clock module, and wherein the controller is configured to control the LEDs based on input of said user interface, sensor, or clock module.
